(19) United States
(12) Patent Application Publication
(10) Pub. No.: US 2018/0093760 A1
(43) Pub. Date: Apr. 5, 2018

(54) FLIGHT CONTROL PUMP SYSTEMS

(71) Applicant: Sikorsky Aircraft Corporation, Stratford, CT (US)

(72) Inventors: Scott J. Young, Milford, CT (US); Frederick L. Bourne, Litchfield, CT (US); William F. Lange, Woodbridge, CT (US)

(21) Appl. No.: 15/723,521

(22) Filed: Oct. 3, 2017

Related U.S. Application Data
(60) Provisional application No. 62/404,450, filed on Oct. 5, 2016.

(51) Int. Cl. B64C 27/02; B64C 27/16; G05D 1/02; F16H 61/00

(52) U.S. Cl. CPC B64C 27/027; B64C 27/16; F16D 43/22; F16H 61/0006; F16H 61/0031; G05D 1/0202

(57) ABSTRACT

A flight control pump system includes an electrical machine configured to operate in a motor mode and in a generator mode. A pump is operatively connected to be driven by the electrical machine in the motor mode. An overriding clutch is operatively connected to the electrical machine and to the pump to transfer torque from a main transmission to drive the pump and the electrical machine in the generator mode, and to decouple the main transmission from the electrical machine and the pump in the motor mode.

### CROSS REFERENCE TO RELATED APPLICATIONS

This application claims the benefit of priority of U.S. Provisional Patent Application No. 62/404,450, filed Oct. 5, 2016. The entire contents of this application are incorporated herein in their entirety.

### BACKGROUND OF THE INVENTION

### 1. Field of the Invention

The present disclosure relates to hydraulic flight control systems, and more particularly to flight control pump systems, such as used in hydraulic control systems for rotorcraft.

### 2. Description of Related Art

Helicopters with hydraulic flight controls require electronically driven check out pumps to verify proper blade control prior to running a rotor head up to speed. This requires a separate motor pump assembly with hydraulic switching that is complex. Switching between hydraulic sources creates pressure spikes and can cause cross-contamination between redundant hydraulic systems, which can reduce the useful life of components and drive up cost of aircraft ownership.

The conventional techniques have been considered satisfactory for their intended purpose. However, there is an ever present need for improved flight control pump systems. This disclosure provides a solution for this problem.

### SUMMARY OF THE INVENTION

A flight control pump system includes an electrical machine configured to operate in a motor mode and in a generator mode. A pump is operatively connected to be driven by the electrical machine in the motor mode. An overriding clutch is operatively connected to the electrical machine and to the pump to transfer torque from a main transmission to drive the pump and the electrical machine in the generator mode, and to decouple the main transmission from the electrical machine and the pump in the motor mode.

A main rotorcraft transmission can be configured to drive a rotorcraft main rotor under power from a main powerplant, wherein the main rotorcraft transmission is operatively connected to the overriding clutch to drive the pump and the electrical machine in the generator mode. An accessory gearbox can operatively connect the electrical machine, the pump, and the overriding clutch. The pump can be in fluid communication with a plurality of hydraulic flight control servos. The electrical machine can be electrically connected to an aircraft power system to supply the aircraft power system in the generator mode.

The electrical machine can be electrically connected to receive power from an auxiliary power system in the motor mode. The auxiliary power system can include a battery operatively connected to an electrical power controller that is operatively connected to a starter motor generator. The starter motor generator can be operatively connected to drive an auxiliary power unit using power from the battery in a startup mode, and to generate electricity under mechanical power from the auxiliary power unit during an engine on mode. The electrical machine can be electrically connected to receive power from the auxiliary power system through a power conditioning unit. The power conditioning unit can be configured to route and condition power from the auxiliary power system to the electrical machine in the motor mode, and to route and condition power from the electrical machine to supply the aircraft power system in the generator mode.

The system can include a second electrical machine configured to operate in a motor mode and in a generator mode, a second pump operatively connected to be driven by the second electrical machine in the motor mode, and a second overriding clutch operatively connected to the second electrical machine and to the second pump to transfer torque from the main transmission to drive the second pump and the second electrical machine in the generator mode, and to decouple the main transmission from the second electrical machine and the second pump in the motor mode.

A first accessory gearbox can operatively connect the first electrical machine, the first pump, and the first overriding clutch. A second accessory gearbox can operatively connect the second electrical machine, the second pump, and the second overriding clutch. The main rotorcraft transmission can be operatively connected to the first and second auxiliary gearboxes through the first and second overriding clutches, respectively, to drive the first and second pumps and the first and second electrical machine in the generator mode. Both of the first and second pumps can be in fluid communication with each of a plurality of hydraulic flight control servos for redundancy. Each of the first and second electrical machines can be electrically connected to a common aircraft power system to supply the aircraft power system in the generator mode.

A method of controlling a flight control pump system includes powering an electrical machine in a motor mode, wherein power is supplied from an auxiliary power system of a rotorcraft prior to powering a main rotor of the rotorcraft. The method also includes driving a pump with the electrical machine, testing hydraulic servos in fluid communication with the pump, powering the main rotor of the rotorcraft, and switching the electrical machine to a generator mode after powering the main rotor of the rotorcraft.

Driving a pump with the electrical machine can include decoupling the pump and electrical machine from a main transmission, wherein the pump and electrical machine are operatively connected to the main transmission by an overriding clutch. The method can include driving the electrical machine and pump with the main transmission after powering the main rotor. The method can include supplying power from the electrical machine to an aircraft power system with the electrical machine in the generator mode.

The method can include powering a second electrical machine in a motor mode, wherein power is supplied from the auxiliary power system of a rotorcraft prior to powering the main rotor of the rotorcraft, driving a second pump with the second electrical machine, testing the hydraulic components in fluid communication with both the first pump and with the second pump, and switching the second electrical machine to a generator mode after powering the main rotor of the rotorcraft.

Testing the hydraulic components can be performed without switching between hydraulic sources. The method can include controlling the rotorcraft using the hydraulic components in fluid communication with the first pump and second pump for redundancy. Supplying power from the auxiliary power system can include starting an auxiliary power unit using a starter motor generator powered by a battery, and switching the starter motor generator to run as a generator to supply the power from the auxiliary power system after starting the auxiliary power unit.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a perspective view of an exemplary embodiment of a rotorcraft constructed in accordance with the present disclosure, showing flight control pump system schematically;

FIG. 2 is a schematic view of the flight control pump system of FIG. 1, showing the system in motor mode, e.g., as in during testing hydraulic servos before spinning up the main rotor; and

FIG. 3 is a schematic view of the flight control pump system of FIG. 1, showing the system in generator mode, e.g., as in after the main rotor is spun up.

### DETAILED DESCRIPTION OF THE PREFERRED EMBODIMENTS

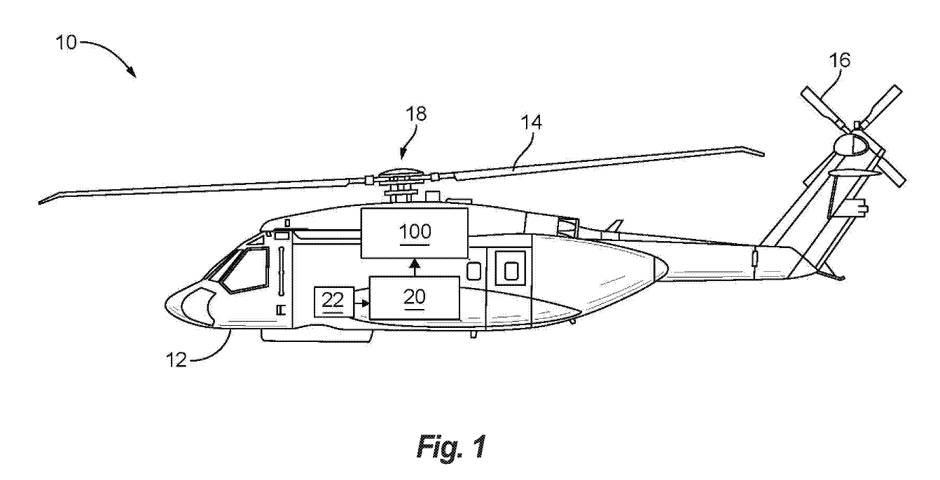

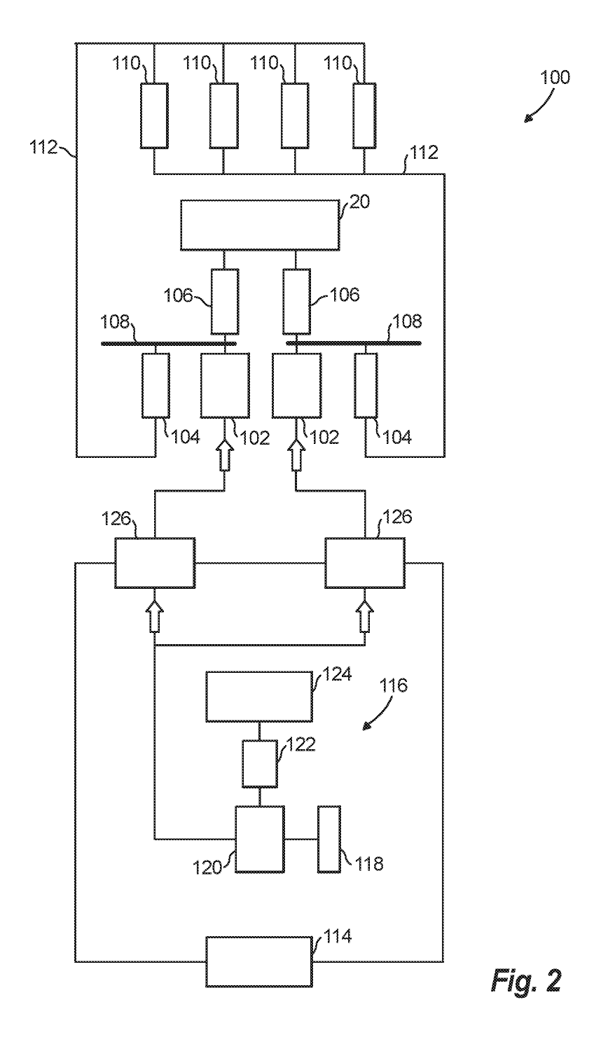

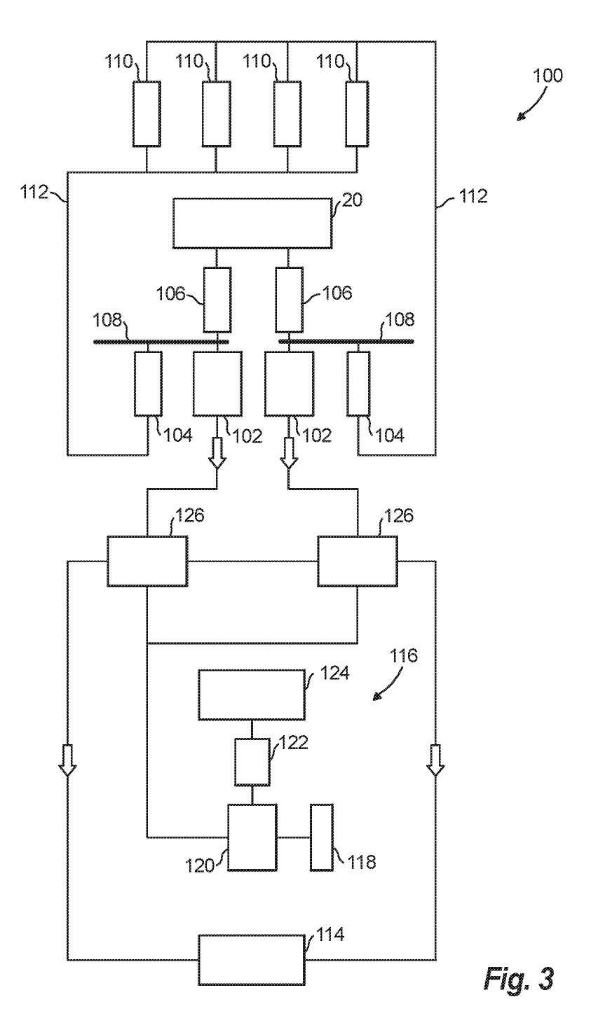

Reference will now be made to the drawings wherein like reference numerals identify similar structural features or aspects of the subject disclosure. For purposes of explanation and illustration, and not limitation, a partial view of an exemplary embodiment of a flight control pump system in accordance with the disclosure is shown in FIG. 1 and is designated generally by reference character 100. Other embodiments of flight control pump systems in accordance with the disclosure, or aspects thereof, are provided in FIGS. 2-3, as will be described. The systems and methods described herein can be used to provide redundancy and to provide pre-flight checking of hydraulic servos in aircraft without having to switch hydraulic sources.

Rotorcraft 10 includes an airframe 12, main rotor 14, and tail rotor 16. Main rotor 14 is driven about its main rotor shaft 18, which is in turn driven by a main transmission 20. Transmission is driven under power from one or more main power plants 22, e.g., gas turbine engines. Flight control pump system 100 is operatively connected to the main transmission 20.

Referring now to FIG. 2, flight control pump system 100 includes first and second electrical machines 102 each configured to operate in a motor mode and in a generator mode. Respective first and second pumps 104 are operatively connected to be driven by the electrical machines 102 in the motor mode. A respective first and second overriding clutch 106 is operatively connected to each of the electrical machines 102 and to the pumps 104 to transfer torque from the main transmission 20 to drive the pumps 104 and the electrical machines 102 in the generator mode, and to decouple the main transmission 20 from the electrical machines 102 and the pumps 104 in the motor mode. The motor mode for electrical machines 102 is indicated schematically in FIG. 2 by the large arrows, which indicate electrical power supplied to drive the electrical machines 102 in the motor mode. The generator mode for electrical machines 102 is indicated schematically in FIG. 3 by the larger arrows, which indicate electrical power supplied from the electrical machines 102 in the generator mode.

A respective accessory gearbox 108 operatively connects each of the first and second electrical machines 102 to the respective pumps 104 overriding clutches 106. The main rotorcraft transmission 20 is operatively connected to the first and second auxiliary gearboxes 108 through the first and second overriding clutches 106, respectively, to drive the first and second pumps 104 and the first and second electrical machines 102 in the generator mode. In the generator mode, the overriding clutches 106 drive the auxiliary gear boxes 108, and in the motor mode, the overriding clutches decouple the auxiliary gear boxes 108 from the main transmission 20 so that the electrical machines do not spin up the main rotor 14 shown in FIG. 1. Both of the first and second pumps are in fluid communication with each of a plurality of hydraulic flight control servos 110 by separate hydraulic lines 112 for redundancy.

Each of the first and second electrical machines 102 is electrically connected to a common aircraft power system 114 to supply electrical power to the aircraft power system 114 in the generator mode. The electrical machines 102 are electrically connected to receive power from an auxiliary power system 116 in the motor mode. The auxiliary power system 116 includes a battery 118 operatively connected to an electrical power controller 120 that is operatively connected to a starter motor generator 122. The starter motor generator 122 is operatively connected to drive an auxiliary power unit 124 using power from the battery 118 in a startup mode, and to generate electricity under mechanical power from the auxiliary power unit 124 during an engine on mode, i.e. after the auxiliary power unit 124 is started. Each of the electrical machines 102 is electrically connected to receive power from the auxiliary power system 116 through a respective power conditioning unit 126. The power conditioning units 126 are each configured to route and condition power from the auxiliary power system 116 to the respective electrical machine 102 in the motor mode (as indicated by the large arrows in FIG. 2), and to route and condition power from the respective electrical machine 102 to supply the aircraft power system 114 in the generator mode (as indicated by the large arrows in FIG. 2). For example, power conditioning units 126 can condition power between a 24 Volt DC battery or aircraft electrical system 114 and 270 Volt AC starter motor generator.

A method of controlling a flight control pump system, e.g., system 100, includes powering an electrical machine, e.g., electrical machine 102, in a motor mode, wherein power is supplied from an auxiliary power system, e.g., auxiliary power system 116, of a rotorcraft prior to powering a main rotor of the rotorcraft, e.g., main rotor 14 of rotorcraft 10. The method also includes driving a pump, e.g., pumps 104, with the electrical machine, testing hydraulic servos, e.g., servos 110, in fluid communication with the pump, powering the main rotor of the rotorcraft, and switching the electrical machine to a generator mode after powering the main rotor of the rotorcraft.

Driving a pump with the electrical machine can include decoupling the pump and electrical machine from a main transmission, e.g., main transmission 20, wherein the pump and electrical machine are operatively connected to the main transmission by an overriding clutch, e.g., overriding clutches 106. The method can include driving the electrical machine and pump with the main transmission after powering the main rotor. The method can include supplying power from the electrical machine to an aircraft power system, e.g., aircraft power system 114, with the electrical machine in the generator mode.

The method can include powering a second electrical machine in a motor mode, wherein power is supplied from the auxiliary power system of a rotorcraft prior to powering the main rotor of the rotorcraft, driving a second pump with the second electrical machine, testing the hydraulic components in fluid communication with both the first pump and with the second pump, and switching the second electrical machine to a generator mode after powering the main rotor of the rotorcraft.

Testing the hydraulic components can be performed without switching between hydraulic sources. The method can include controlling the rotorcraft using the hydraulic components in fluid communication with the first pump and second pump for redundancy. Supplying power from the auxiliary power system can include starting an auxiliary power unit using a starter motor generator powered by a battery, e.g., starter motor generator 122 and battery 118, and switching the starter motor generator to run as a generator to supply the power from the auxiliary power system after starting the auxiliary power unit.

Those skilled in the art will readily appreciate that while described herein in the exemplary context of two redundant hydraulic pumps, any suitable number of pumps can be used without departing from the scope of this disclosure. Potential benefits of systems and methods disclosed herein include weight and complexity are driven down and reliability is increased relative to conventional systems that switch hydraulic sources between a hydraulic supply module and two different transfer modules. Switching between hydraulic sources creates pressure spikes which can damage components and drive up cost of aircraft ownership, and can lead to cross-contamination among the hydraulic sources. Architectures described in this disclosure drive redundant systems in parallel with no switching needed between sources.

The methods and systems of the present disclosure, as described above and shown in the drawings, provide for flight control pump systems and methods with superior properties including redundancy, reduced weight, and pre-flight checking of hydraulic servos in aircraft without having to switch hydraulic sources. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A flight control pump system comprising:
an electrical machine configured to operate in a motor mode and in a generator mode;
a pump operatively connected to be driven by the electrical machine in the motor mode; and
an overriding clutch operatively connected to the electrical machine and to the pump to transfer torque from a main transmission to drive the pump and the electrical machine in the generator mode, and to decouple the main transmission from the electrical machine and the pump in the motor mode.

2. A system as recited in claim 1, further comprising a main rotorcraft transmission configured to drive a rotorcraft main rotor under power from a main powerplant, wherein the main rotorcraft transmission is operatively connected to the overriding clutch to drive the pump and the electrical machine in the generator mode.

3. A system as recited in claim 1, wherein an accessory gearbox operatively connects the electrical machine, the pump, and the overriding clutch.

4. A system as recited in claim 1, wherein the pump is in fluid communication with a plurality of hydraulic flight control servos.

5. A system as recited in claim 1, wherein the electrical machine is electrically connected to an aircraft power system to supply the aircraft power system in the generator mode.

6. A system as recited in claim 1, wherein the electrical machine is electrically connected to receive power from an auxiliary power system in the motor mode.

7. A system as recited in claim 6, wherein the auxiliary power system includes a battery operatively connected to an electrical power controller that is operatively connected to a starter motor generator, wherein the starter motor generator is operatively connected to drive an auxiliary power unit using power from the battery in a startup mode, and to generate electricity under mechanical power from the auxiliary power unit during an engine on mode.

8. A system as recited in claim 5, wherein the electrical machine is electrically connected to receive power from the auxiliary power system through a power conditioning unit, wherein the power conditioning unit is configured to route and condition power from the auxiliary power system to the electrical machine in the motor mode, and to route and condition power from the electrical machine to supply the aircraft power system in the generator mode.

9. A system as recited in claim 1, wherein the electrical machine is a first electrical machine, wherein the pump is a first pump, and wherein the overriding clutch is a first overriding clutch, and further comprising:
a second electrical machine configured to operate in a motor mode and in a generator mode;
a second pump operatively connected to be driven by the second electrical machine in the motor mode; and
a second overriding clutch operatively connected to the second electrical machine and to the second pump to transfer torque from the main transmission to drive the second pump and the second electrical machine in the generator mode, and to decouple the main transmission from the second electrical machine and the second pump in the motor mode.

10. A system as recited in claim 9, further comprising:
a first accessory gearbox operatively connecting the first electrical machine, the first pump, and the first overriding clutch;
a second accessory gearbox operatively connecting the second electrical machine, the second pump, and the second overriding clutch; and
a main rotorcraft transmission configured to drive a rotorcraft main rotor under power from a main powerplant, wherein the main rotorcraft transmission is operatively connected to the first and second auxiliary gearboxes through the first and second overriding clutches, respectively, to drive the first and second pumps and the first and second electrical machine in the generator mode.

11. A system as recited in claim 9, wherein both of the first and second pumps are in fluid communication with each of a plurality of hydraulic flight control servos for redundancy.

12. A system as recited in claim 9, wherein each of the first and second electrical machines is electrically connected to a common aircraft power system to supply the aircraft power system in the generator mode.

13. A method of controlling a flight control pump system comprising:
powering an electrical machine in a motor mode, wherein power is supplied from an auxiliary power system of a rotorcraft prior to powering a main rotor of the rotorcraft;
driving a pump with the electrical machine;
testing hydraulic servos in fluid communication with the pump;
powering the main rotor of the rotorcraft; and
switching the electrical machine to a generator mode after powering the main rotor of the rotorcraft.

14. A method as recited in claim 13, wherein driving a pump with the electrical machine includes decoupling the pump and electrical machine from a main transmission, wherein the pump and electrical machine are operatively connected to the main transmission by an overriding clutch.

15. A method as recited in any of claim 14, further comprising driving the electrical machine and pump with the main transmission after powering the main rotor.

16. A method as recited in claim 13, further comprising supplying power from the electrical machine to an aircraft power system with the electrical machine in the generator mode.

17. A method as recited in claim 13, wherein the electrical machine is a first electrical machine and the pump is a first pump, and further comprising:
powering a second electrical machine in a motor mode, wherein power is supplied from the auxiliary power system of a rotorcraft prior to powering the main rotor of the rotorcraft;
driving a second pump with the second electrical machine;
testing the hydraulic components in fluid communication with both the first pump and with the second pump; and
switching the second electrical machine to a generator mode after powering the main rotor of the rotorcraft.

18. A method as recited in claim 17, wherein testing the hydraulic components is performed without switching between hydraulic sources.

19. A method as recited in claim 17, further comprising controlling the rotorcraft using the hydraulic components in fluid communication with the first pump and second pump for redundancy.

20. A method as recited in claim 13, wherein supplying power from the auxiliary power system includes:
starting an auxiliary power unit using a starter motor generator powered by a battery; and
switching the starter motor generator to run as a generator to supply the power from the auxiliary power system after starting the auxiliary power unit.
